(19) United States
(12) Patent Application Publication
(10) Pub. No.: US 2026/0135041 A1
(43) Pub. Date: May 14, 2026

(54) MULTILAYER CERAMIC ELECTRONIC COMPONENT

(71) Applicant: Murata Manufacturing Co., Ltd., Nagaokakyo-shi (JP)

(72) Inventor: Kota ZENZAI, Nagaokakyo-shi (JP)

(21) Appl. No.: 19/442,065

(22) Filed: Jan. 7, 2026

Related U.S. Application Data
(63) Continuation of application No. PCT/JP2024/013805, filed on Apr. 3, 2024.

(30) Foreign Application Priority Data
Aug. 29, 2023 (JP) 2023-139087

(51) Int. Cl. H01G 4/30; H01G 4/232

(52) U.S. Cl. CPC H01G 4/30; H01G 4/232

(57) ABSTRACT

A multilayer ceramic electronic component includes a multilayer ceramic capacitor including a multilayer body and two outer electrodes, a first spacer connected to one of the two outer electrodes, a second spacer connected to another of the two outer electrodes, and a third spacer between the first spacer and the second spacer. The multilayer body includes a first surface on a non-mounting surface side. A color of the first surface is different from a color of the third spacer.

### CROSS REFERENCE TO RELATED APPLICATIONS

This application claims the benefit of priority to Japanese Patent Application No. 2023-139087 filed on Aug. 29, 2023 and is a Continuation Application of PCT Application No. PCT/JP2024/013805 filed on Apr. 3, 2024. The entire contents of each application are hereby incorporated herein by reference.

### BACKGROUND OF THE INVENTION

### 1. Field of the Invention

The present invention relates to multilayer ceramic electronic components.

### 2. Description of the Related Art

In recent years, a large number of multilayer ceramic capacitors, which are chip electronic components, have been used in electronic devices. The performance of such electronic devices in which multilayer ceramic capacitors are used has been improving. Accordingly, the performance of multilayer ceramic capacitors also has been improved by, for example, reducing size and increasing capacitance.

A multilayer ceramic capacitor includes an inner layer portion in which dielectric layers and inner electrodes are alternately stacked. The multilayer ceramic capacitor is formed by forming a rectangular-parallelepiped multilayer body in which dielectric layers are disposed as outer layer portions on an upper portion and a lower portion of the inner layer portion, and providing outer electrodes on both end surfaces of the multilayer body in the longitudinal direction. The multilayer ceramic capacitor has an electrostatic capacitance because inner electrodes face each other with a dielectric layer therebetween. It is known that the multilayer ceramic capacitor may generate acoustic noise when vibration occurs due to piezoelectricity and the vibration is transmitted to a substrate.

In order to reduce or prevent generation of acoustic noise, for example, it is effective to separate the multilayer ceramic capacitor from the substrate. Therefore, for example, a known multilayer ceramic electronic component includes a bump (spacer) that is provided on a side of an electrode multilayer ceramic capacitor to be mounted on the substrate so as to cover a portion of an outer electrode.

For example, U.S. Pat. No. 10,542,626 describes a multilayer ceramic electronic component including a bump that is made of a substrate material having a high rigidity and a high Young's modulus, such as alumina. International Publication No. 2018/101405 describes a multilayer ceramic electronic component including a spacer that is formed by applying a spacer forming paste onto a multilayer ceramic capacitor and by performing heat treatment.

However, with the multilayer ceramic electronic component described in U.S. Pat. No. 10,542,626 and the multilayer ceramic electronic component described in International Publication No. 2018/101405, each of which is disclosed as a multilayer ceramic electronic component that is configured to reduce acoustic noise, it is difficult to distinguish between a mounting surface side and a non-mounting surface side because the mounting surface side and the non-mounting surface side have the same color. In particular, it is difficult to distinguish between the mounting surface side and the non-mounting surface side when the outer electrode and the spacer include components of the same type.

### SUMMARY OF THE INVENTION

Example embodiments of the present invention provide multilayer ceramic electronic components each with reduced acoustic noise and with each of which it is easy to distinguish between a mounting surface side and a non-mounting surface side.

A multilayer ceramic electronic component according to an example embodiment of the present invention includes a multilayer ceramic capacitor including a multilayer body and two outer electrodes, a first spacer connected to one of the two outer electrodes, a second spacer connected to another of the two outer electrodes, and a third spacer between the first spacer and the second spacer. The multilayer body includes a second surface on a non-mounting surface side. A color of the second surface is different from a color of the third spacer.

With example embodiments of the present invention, multilayer ceramic electronic components each with reduced acoustic noise and with each of which it is easy to distinguish between a mounting surface side and a non-mounting surface side are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a multilayer ceramic electronic component according to an example embodiment of the present invention.

FIG. 2 is an external perspective view of a multilayer ceramic capacitor according to an example embodiment of the present invention.

FIG. 3 is a sectional view taken along line III-III of FIG. 2.

FIG. 4 is a sectional view taken along line IV-IV of FIG. 2.

FIG. 5 is a front view of a multilayer ceramic electronic component according to an example embodiment of the present invention.

FIG. 6 is a bottom view of a multilayer ceramic electronic component according to an example embodiment of the present invention.

FIG. 7 illustrates a multilayer ceramic electronic component according to an example embodiment of the present invention in a mounted state.

FIG. 8 is a bottom view of a multilayer ceramic electronic component according to an example embodiment of the present invention.

### DETAILED DESCRIPTION OF THE EXAMPLE EMBODIMENTS

Example embodiments of the present invention will be described in detail below with reference to the drawings.

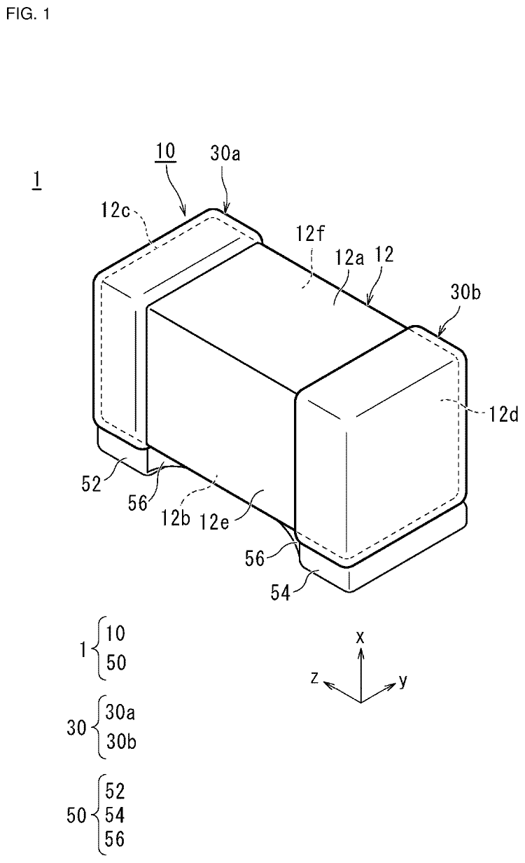

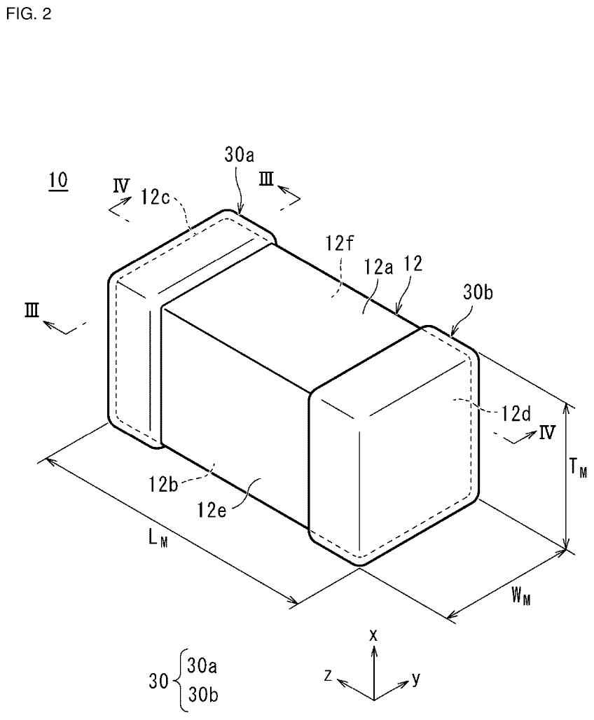

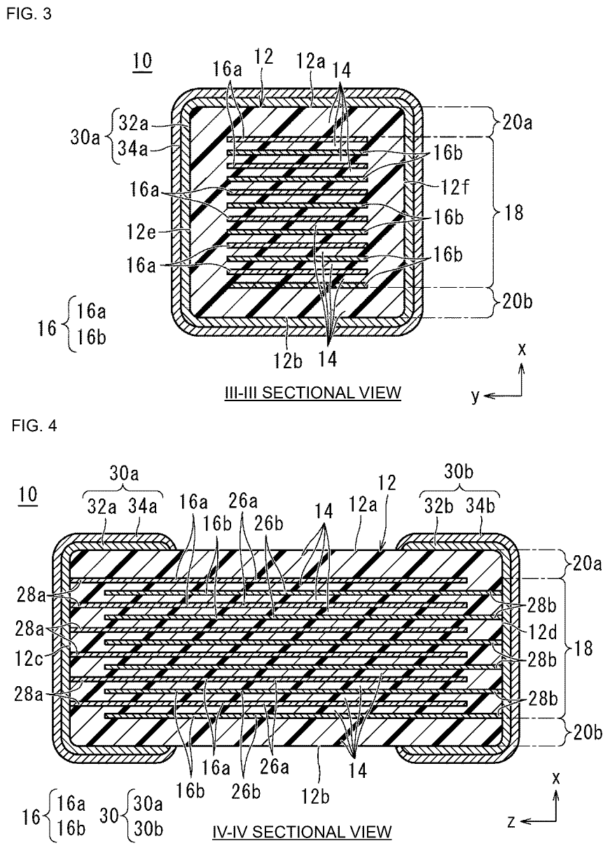

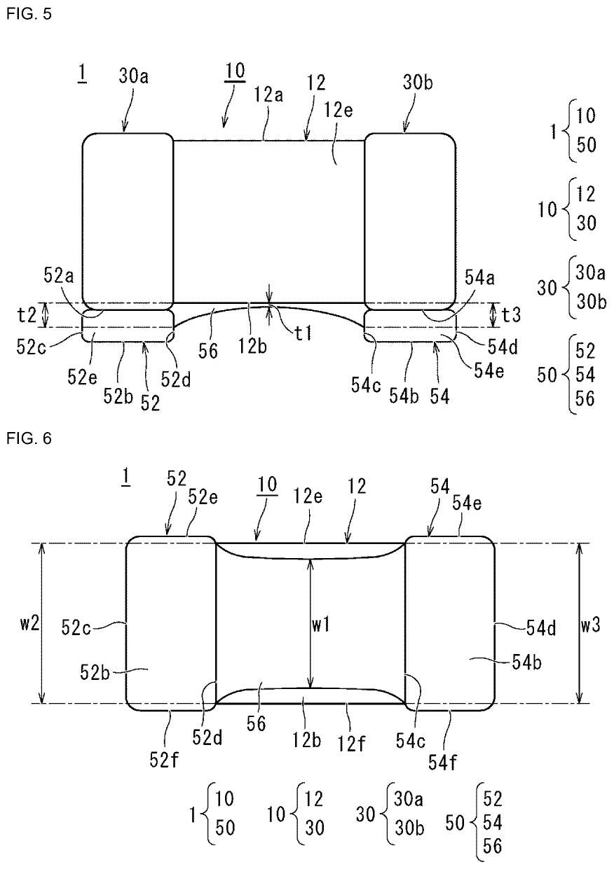

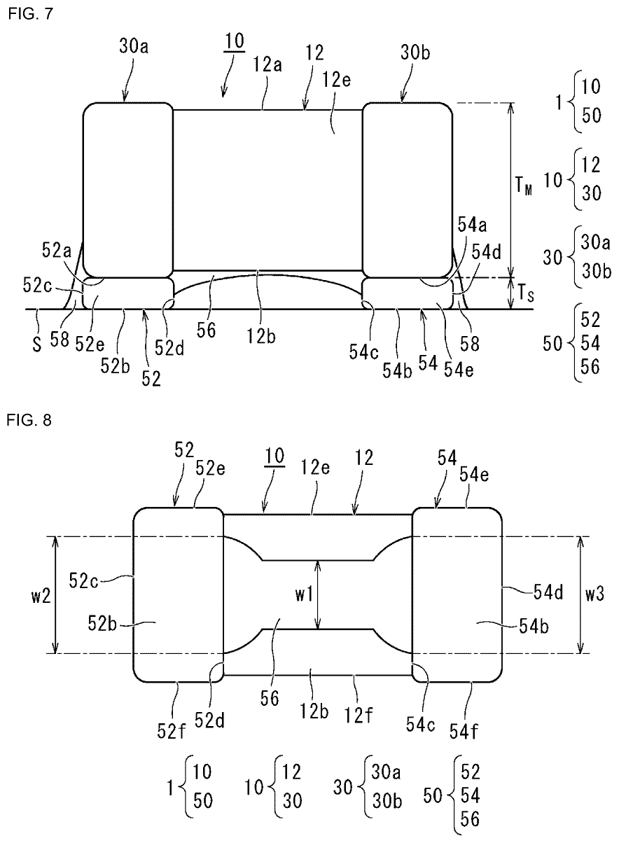

Referring to FIGS. 1 to 8, multilayer ceramic electronic components 1 according to example embodiments of the present invention will be described. FIG. 1 is an external perspective view of a multilayer ceramic electronic component according to an example embodiment of the present invention. FIG. 2 is an external perspective view of a multilayer ceramic capacitor according to an example embodiment of the present invention. FIG. 3 is a sectional view taken along line III-III of FIG. 2. FIG. 4 is a sectional view taken along line IV-IV of FIG. 2. FIG. 5 is a front view of a multilayer ceramic electronic component according to an example embodiment of the present invention. FIG. 6 is a bottom view of a multilayer ceramic electronic component according to an example embodiment of the present invention. FIG. 7 illustrates a multilayer ceramic electronic component according to an example embodiment of the present invention in a mounted state. FIG. 8 is a bottom view of a multilayer ceramic electronic component according to an example embodiment of the present invention.

A multilayer ceramic electronic component 1 according to an example embodiment of the present invention includes a multilayer ceramic capacitor 10 including a multilayer body 12 and two outer electrodes 30a and 30b, a first spacer 52 connected to the outer electrode 30a, a second spacer 54 connected to the outer electrode 30b, and a third spacer 56 disposed between the first spacer 52 and the second spacer 54.

The multilayer body 12 includes a plurality of dielectric layers 14 that are stacked and a plurality of inner electrodes 16 that are stacked on the dielectric layers 14. The multilayer body 12 includes a first surface 12a and a second surface 12b that face each other in a height direction x, a third surface 12c and a fourth surface 12d that face each other in a length direction z perpendicular or substantially perpendicular to the height direction x, and a fifth surface 12e and a sixth surface 12f that face each other in a width direction y perpendicular or substantially perpendicular to the height direction x and the length direction z. In the present example embodiment, the first surface 12a side of the multilayer body 12 is a non-mounting surface side, and the second surface 12b side of the multilayer body 12 is a mounting surface side. The height direction x is a direction perpendicular or substantially perpendicular to a mounting surface S. The width direction y connecting the fifth surface 12e and the sixth surface 12f of the multilayer body 12 may be the stacking direction.

The multilayer body 12 has a hexahedral or substantially hexahedral shape. It is preferable that the vertices and the edges of the multilayer body 12 are rounded. Here, a vertex is a portion where adjacent three surfaces of the multilayer body 12 intersect, and an edge is a portion where adjacent two surfaces of the multilayer body 12 intersect. Moreover, protrusions and recesses or the like may be provided on a portion or all of the first surface 12a, the second surface 12b, the third surface 12c, the fourth surface 12d, the fifth surface 12e, and the sixth surface 12f.

The multilayer body 12 includes an inner layer portion 18 in which the plurality of inner electrodes 16 face each other. In other words, in the inner layer portion 18, a first inner electrode 16a and a second inner electrode 16b face each other.

The multilayer body 12 includes a first outer layer portion 20a that is positioned on the first surface 12a side and that includes a plurality of dielectric layers 14 that are positioned between the first surface 12a and the outermost surface of the inner layer portion 18 on the first surface 12a side and an extension of the outermost surface.

Similarly, the multilayer body 12 includes a second outer layer portion 20b that is positioned on the second surface 12b side and that includes a plurality of dielectric layers 14 that are positioned between the second surface 12b and the outermost surface of the inner layer portion 18 on the second surface 12b side and an extension of the outermost surface.

As the ceramic material of the dielectric layer 14, for example, it is possible to use a dielectric ceramic including a main component that is BaTiO₃, CaTiO₃, SrTiO₃, CaZrO₃, or the like. A substance including such a main component and a subcomponent, such as, for example, an Mn compound, an Fe compound, a Cr compound, a Co compound, or an Ni compound, may be used.

It is preferable that the thickness of the dielectric layer 14 is, for example, about 0.5 μm or more and about 10 μm or less. Moreover, it is preferable that the number of the dielectric layers 14, inclusive of the first outer layer portion 20a and the second outer layer portion 20b, is, for example, 10 or more and 700 or less.

The inner electrodes 16 include a plurality of first inner electrodes 16a and a plurality of second inner electrodes 16b.

The first inner electrodes 16a are disposed on the plurality of dielectric layers 14 and exposed on the third surface 12c.

The second inner electrodes 16b are disposed on the plurality of dielectric layers 14 and exposed on the fourth surface 12d.

Each first inner electrode 16a includes a first counter electrode portion 26a facing a corresponding one of the second inner electrodes 16b and a first extension electrode portion 28a extending from the first counter electrode portion 26a to the third surface 12c of the multilayer body 12. An end portion of the first extension electrode portion 28a of the first inner electrode 16a extends to the third surface 12c of the multilayer body 12 and defines an exposed portion.

Each second inner electrode 16b includes a second counter electrode portion 26b facing a corresponding one of the first inner electrodes 16a and a second extension electrode portion 28b extending from the second counter electrode portion 26b to the fourth surface 12d of the multilayer body 12. An end portion of the second extension electrode portion 28b of the second inner electrode 16b extends to the fourth surface 12d of the multilayer body 12 and defines an exposed portion.

It is preferable that the shapes of the first counter electrode portion 26a of the first inner electrode 16a and the second counter electrode portion 26b of the second inner electrode 16b are rectangular or substantially rectangular, although not particularly limited. However, corner portions may be rounded, or corner portions may be chamfered (tapered).

It is preferable that the shapes of the first extension electrode portion 28a of the first inner electrode 16a and the second extension electrode portion 28b of the second inner electrode 16b are rectangular or substantially rectangular, although not particularly limited. However, corner portions may be rounded, or corner portions may be chamfered (tapered).

The width the first counter electrode portion 26a of the first inner electrode 16a and the second counter electrode portion 26b of the second inner electrode 16b and the width of the first extension electrode portion 28a of the first inner electrode 16a and the second extension electrode portion 28b of the second inner electrode 16b may be the same or substantially the same, or either of these widths may be narrower than the other.

In the present example embodiment, counter electrode portions 26 of the inner electrodes 16 face each other with the dielectric layer 14 therebetween, and thus electrostatic capacitance is generated and capacitor characteristics are provided.

The first inner electrode 16a and the second inner electrode 16b can be made from any appropriate electroconductive material that is, for example, a metal such as Ni, Cu, Ag, Pd, or Au, or an alloy including at least one of these metals, such as Ag—Pd alloy.

When the first inner electrode 16a and the second inner electrode 16b include Sn, concentration of electric field on the interface between the inner electrode 16 and the dielectric layer 14 can be reduced and thus high-temperature load reliability can be improved. In this case, Sn is sufficiently effective even if Sn is included only in either one of the inner electrodes 16, which include the first inner electrode 16a and the second inner electrode 16b.

It is preferable that the thickness of each of the first inner electrode 16a and the second inner electrode 16b is, for example, about 0.2 μm or more and about 2.0 μm or less. It is preferable that the number of the inner electrodes 16 is, for example, 10 or more and 700 or less.

Outer electrodes 30 include a first outer electrode 30a and a second outer electrode 30b.

The first outer electrode 30a is connected to the first inner electrodes 16a and disposed on the third surface 12c. The first outer electrode 30a may also be disposed on a portion of the first surface 12a, a portion of the second surface 12b, a portion of the fifth surface 12e, and a portion of the sixth surface 12f. In the present example embodiment, the first outer electrode 30a extends from the third surface 12c to a portion of the first surface 12a, a portion of the second surface 12b, a portion of the fifth surface 12e, and a portion of the sixth surface 12f.

The second outer electrode 30b is connected to the second inner electrodes 16b and disposed on the fourth surface 12d. The second outer electrode 30b may also be disposed on a portion of the first surface 12a, a portion of the second surface 12b, a portion of the fifth surface 12e, and a portion of the sixth surface 12f. In the present example embodiment, the second outer electrode 30b extends from the fourth surface 12d to a portion of the first surface 12a, a portion of the second surface 12b, a portion of the fifth surface 12e, and a portion of the sixth surface 12f.

The first outer electrode 30a and the second outer electrode 30b include an underlying electrode layer 32 disposed on surfaces of the multilayer body 12 and a plating layer 34 covering the underlying electrode layer 32.

The underlying electrode layer 32 is disposed on the third surface 12c and on the fourth surface 12d. On each of the first outer electrode 30a side and the second outer electrode 30b side, the underlying electrode layer 32 may also be disposed on a portion of the first surface 12a, a portion of the second surface 12b, a portion of the fifth surface 12e, and a portion of the sixth surface 12f. In the present example embodiment, on each of the first outer electrode 30a side and on the second outer electrode 30b side, the underlying electrode layer 32 extends from the third surface 12c and the fourth surface 12d to a portion of the first surface 12a, a portion of the second surface 12b, a portion of the fifth surface 12e, and a portion of the sixth surface 12f.

The underlying electrode layer 32 includes a first underlying electrode layer 32a and a second underlying electrode layer 32b.

The underlying electrode layer 32 includes at least one of, for example, a baked layer, an electroconductive resin layer, a thin film layer, and the like.

The baked layer includes a glass component and a metal. The glass component of the baked layer includes, for example, at least one of B, Si, Ba, Mg, Al, or Li. The metal of the baked layer includes, for example, at least one of Cu, Ni, Ag, Pd, Ag—Pd alloy, Au, or the like.

The baked layer may include a plurality of layers. The baked layer is formed by applying an electroconductive paste including glass and a metal to the multilayer body 12 and baking the electroconductive paste. The baked layer may be formed by simultaneously baking a multilayer chip including the inner electrode 16 and the dielectric layer 14 and an electroconductive paste applied to the multilayer chip. The baked layer may be formed by firing a multilayer chip including the inner electrode 16 and the dielectric layer 14 to obtain the multilayer body 12 and then applying an electroconductive paste to the multilayer body 12 and baking the electroconductive paste. When a multilayer chip including the inner electrode 16 and the dielectric layer 14 and an electroconductive paste applied to the multilayer chip are to be simultaneously fired, it is preferable that the baked layer is formed by baking an electroconductive paste to which, instead of a glass component, a dielectric material is added.

It is preferable that the thickness of a first baked layer, positioned on the third surface 12c, in a length direction z, connecting the third surface 12c and the fourth surface 12d, at a central portion in a height direction x, connecting the first surface 12a and the second surface 12b, (that is, the thickness of the underlying electrode layer at a central portion of the third surface 12c) is, for example, about 3 μm or more and about 160 μm or less.

It is preferable that the thickness of a second baked layer, positioned on the fourth surface 12d, in the length direction z, connecting the third surface 12c and the fourth surface 12d, at a central portion in the height direction x, connecting the first surface 12a and the second surface 12b, (that is, the thickness of the underlying electrode layer at a central portion of the fourth surface 12d) is, for example, about 3 μm or more and about 160 μm or less.

It is preferable that the thickness of the first baked layer, positioned on a portion of the first surface 12a and a portion of the second surface 12b, in the height direction x, connecting the first surface 12a and the second surface 12b, at a central portion in the length direction z, connecting the third surface 12c and the fourth surface 12d, is, for example, about 3 μm or more and about 40 μm or less.

It is preferable that the thickness of the second baked layer, positioned on a portion of the first surface 12a and a portion of the second surface 12b, in the height direction x, connecting the first surface 12a and the second surface 12b, at a central portion in the length direction z, connecting the third surface 12c and the fourth surface 12d, is, for example, about 3 μm or more and about 40 μm or less.

When an electroconductive resin layer is provided as the underlying electrode layer 32, the electroconductive resin layer may cover the baked layer. The baked layer may be omitted, and the electroconductive resin layer may be disposed directly on the multilayer body 12.

The electroconductive resin layer may completely cover the underlying electrode layer 32 or may cover a portion of the underlying electrode layer 32.

The electroconductive resin layer may include a plurality of layers.

The electroconductive resin layer includes, for example, a thermosetting resin and a metal component.

It is possible to use, as the thermosetting resin, any appropriate known thermosetting resin such as, for example, epoxy resin, phenol resin, urethane resin, silicone resin, or polyimide resin. Among these, epoxy resin is preferable in terms of heat resistance, humidity resistance, adherence, and the like.

It is preferable that the electroconductive resin layer includes a hardener, in addition to a thermosetting resin. When epoxy resin is used as a base resin, it is possible to use, as the hardener, any appropriate known compound such as, for example, a phenol-based compound, an amine-based compound, an acid-anhydride-based compound, an imidazole-based compound, an active-ester compound, or an amide-imide compound.

As the metal included in the electroconductive resin layer, it is possible to use, for example, Ag, Cu, Ni, Sn, or Bi, or an alloy including these. It is also possible to use, for example, metal powder whose surface is coated with Ag. When metal powder whose surface is coated with Ag is used, it is preferable to use, for example, as the metal powder, powder of Cu, Ni, Sn, or Bi, or an alloy of these. The reason that electroconductive metal powder of Ag is preferably used as the metal included in the electroconductive resin layer is that Ag, which has the lowest specific resistance among all metals, is suitable for an electrode material, and that Ag, which is a precious metal, does not oxidize and has high weather resistance. Another reason is that it is possible to reduce the cost of the base material while maintaining the characteristics of Ag. Moreover, as the metal included in the electroconductive resin layer, it is also possible to use, for example, Cu or Ni that is anti-oxidation treated. As the metal included in the electroconductive resin layer, it is also possible to use, for example, metal powder whose surface is coated with Sn, Ni, or Cu. When metal powder whose surface is coated with Sn, Ni, or Cu is used, it is preferable to use, for example, as the metal powder, Ag, Cu, Ni, Sn, or Bi, or an alloy of these.

As the metal included in the electroconductive resin layer, it is possible to use spherical metal powder, flat metal powder, or the like. However, it is preferable to use a mixture of spherical metal powder and flat metal powder. The metal included in the electroconductive resin layer mainly provides the electroconductivity of the electroconductive resin layer. To be specific, due to contact between electroconductive fillers (metals included in the electroconductive resin layer), a conduction path is provided in the electroconductive resin layer.

The electroconductive resin layer, which includes a thermosetting resin, is softer than, for example, the underlying electrode layer made from a plating film or a fired electroconductive paste. Therefore, even when a physical impact or an impact due to a thermal cycle is applied to the multilayer ceramic capacitor, the electroconductive resin layer defines and functions as a cushioning layer and can reduce or prevent cracking of the multilayer ceramic capacitor.

It is preferable that the thickness of the thickest portion of the electroconductive resin layer is, for example, about 10 μm or more and about 150 μm or less.

The thin film layer is a layer that has, for example, a thickness of about 1 μm or less and that is formed by depositing metal particles by using a thin-film forming method such as sputtering, vapor deposition, or the like, for example.

The plating layer 34 includes a first plating layer 34a and a second plating layer 34b.

The first plating layer 34a covers the first underlying electrode layer 32a.

The second plating layer 34b covers the second underlying electrode layer 32b.

The plating layer 34 includes, for example, at least one of Cu, Ni, Sn, Ag, Pd, Ag—Pd alloy, Au, or the like.

The plating layer 34 may include a plurality of layers. Preferably, the plating layer 34 may have a double-layered structure including, for example, an Ni plating layer and an Sn plating layer. The Ni plating layer can prevent the underlying electrode layer 32 from being eroded by solder when the multilayer ceramic electronic component 1 is being mounted. The Sn plating layer can increase the wettability of solder when the multilayer ceramic electronic component 1 is being mounted and allow the multilayer ceramic electronic component 1 to be easily mounted.

It is preferable that the thickness of one plating layer 34 is, for example, about 2 μm or more and about 15 μm or less.

The outer electrode 30 may include only the plating layer 34, and the underlying electrode layer 32 may be omitted. Hereafter, a structure in which the outer electrode 30 includes only the plating layer 34 and the underlying electrode layer 32 is omitted will be described.

The underlying electrode layer 32 may be omitted, and the first outer electrode 30a and the second outer electrode 30b may include only the plating layer 34 that is provided directly on surfaces of the multilayer body 12. That is, the multilayer ceramic capacitor 10 may have a structure including the plating layer 34 that is directly connected to the first inner electrode 16a and the second inner electrode 16b. In such a case, the plating layer 34 may be formed after disposing a catalyst on surfaces of the multilayer body 12 as preprocessing.

When the underlying electrode layer 32 is omitted and a plating layer is provided directly on the multilayer body 12, it is possible to use the reduction of the thickness of the underlying electrode layer 32 to reduce the height of the multilayer ceramic capacitor 10, that is, to reduce the profile, or to increase of the thickness of the multilayer body 12, that is, the thickness of the inner layer portion 18 (effective layer portion), and therefore it is possible to increase the freedom in design of a thin chip.

It is preferable that the plating layer 34 includes a lower plating electrode provided on the surface of the multilayer body 12, and an upper plating electrode provided on the surface of the lower plating electrode.

It is preferable that each of the lower plating electrode and the upper plating electrode include, for example, at least one metal of Cu, Ni, Sn, Pb, Au, Ag, Pd, Bi, or Zn, or an alloy including the metal.

It is preferable that the lower plating electrode is made of, for example, Ni having solder barrier performance, and it is preferable that the upper plating electrode is made of, for example, Sn or Au having good solder wettability.

For example, when the first inner electrode 16a and the second inner electrode 16b are made of Ni, it is preferable that the lower plating electrode is made of Cu that can be easily joined to Ni. The upper plating electrode may be provided as necessary, and each of the first outer electrode 30a and the second outer electrode 30b may include only the lower plating electrode.

The plating layer 34 may include the upper plating electrode as the outermost layer, or another plating electrode may be additionally provided on the surface of the upper plating electrode.

When the underlying electrode layer 32 is omitted, it is preferable that the thickness of one plating layer 34 is, for example, about 1 μm or more and about 15 μm or less. It is preferable that the plating layer 34 does not include glass. It is preferable that the percentage of metal per unit volume of the plating layer 34 is, for example, about 99 volume % or higher.

Dimension L_{M} is the dimension of the multilayer ceramic capacitor 10 in the length direction z. It is preferable that the dimension L_{M} is, for example, about 0.2 mm or more and about 10 mm or less. Dimension W_{M} is the dimension of the multilayer ceramic capacitor 10 in the width direction y. It is preferable that the dimension W_{M} is, for example, about 0.1 mm or more and about 5 mm or less. Dimension T_{M} is the dimension of the multilayer ceramic capacitor 10 in the height direction x. It is preferable that the dimension T_{M} is, for example, about 0.1 mm or more and about 5 mm or less.

The multilayer ceramic electronic component 1 includes the multilayer ceramic capacitor 10 and a spacer 50. The spacer 50 includes the first spacer 52 covering at least a portion of the first outer electrode 30a, the second spacer 54 covering at least a portion of the second outer electrode 30b, and the third spacer 56 covering a portion of the multilayer body 12, a portion of the first spacer 52, and a portion of the second spacer 54. In the present example embodiment, although the first spacer 52, the second spacer 54, and the third spacer 56 will be described independently, the first spacer 52, the second spacer 54, and the third spacer 56 may be integrated and indistinguishable from each other.

The first spacer 52 is disposed between the first outer electrode 30a and a mounting surface S and connected to the first outer electrode 30a. The second spacer 54 is disposed between the second outer electrode 30b and the mounting surface S and connected to the second outer electrode 30b.

The shapes of the first spacer 52 and the second spacer 54 are not particularly limited. In other words, the shapes of the first spacer 52 and the second spacer 54 may be, for example, hexahedral or substantially hexahedral shapes, or recessed shapes or H-like shapes including opening regions on the third surface 12c side and the fourth surface 12d side of the multilayer body 12, or the first spacer 52 and the second spacer 54 may be disposed discontinuously in a four-leg shape. When the first spacer 52 and the second spacer 54 include opening regions that open on the third surface 12c side and the fourth surface 12d side of the multilayer body 12, a portion of solder used for mounting flows into the opening regions of the first spacer 52 and the second spacer 54. Thus, it is possible to reduce the amount of solder that wets the third surface 12c and the fourth surface 12d of the multilayer body 12, and thus an advantageous effect of reduce or preventing acoustic noise is obtained. This is not a limitation, and the shapes may be cloud shapes including a plurality of protrusions and/or recesses when viewed from the bottom surface (the mounting surface side). In the following description, it is assumed that the first spacer 52 and the second spacer 54 have hexahedral or substantially hexahedral shapes.

The first spacer 52 includes a first surface 52a and a second surface 52b that face each other in the height direction x, a third surface 52c and a fourth surface 52d that face each other in the length direction z that is perpendicular or substantially perpendicular to the height direction x, and a fifth surface 52e and a sixth surface 52f that face each other in the width direction y that is perpendicular or substantially perpendicular to the height direction x and the length direction z. The first surface 52a of the first spacer 52 is connected to the first outer electrode 30a. The second surface 52b of the first spacer 52 is connected to the mounting surface S. In the first spacer 52, an edge portion of the first spacer 52 on the central side of the multilayer ceramic capacitor 10 (a ridge portion where the first surface 52a and the fourth surface 52d intersect) may be positioned closer to the center of the multilayer ceramic capacitor 10 than an end portion of the first outer electrode 30a on the central side.

The second spacer 54 includes a first surface 54a and a second surface 54b that face each other in the height direction x, a third surface 54c and a fourth surface 54d that a face each other in the length direction z that is perpendicular or substantially perpendicular to the height direction x, and a fifth surface 54e and a sixth surface 54f that face each other in the width direction y that is perpendicular or substantially perpendicular to the height direction x and the length direction z. The first surface 54a of the second spacer 54 is connected to the second outer electrode 30b. The second surface 54b of the second spacer 54 is connected to the mounting surface S. In the second spacer 54, an edge portion of the second spacer 54 on the central side of the multilayer ceramic capacitor 10 (a ridge portion where the first surface 54a and the third surface 54c intersect) may be positioned closer to the center of the multilayer ceramic capacitor 10 than an end portion of the second outer electrode 30b on the central side.

Because the first spacer 52 and the second spacer 54 are disposed between the multilayer ceramic capacitor 10 and the mounting surface S, it is possible to increase the distance between the inner layer portion 18, which is the capacitance generating portion of the multilayer ceramic capacitor 10, and the mounting surface S, and therefore it is possible to reduce or prevent acoustic noise.

In this case, although it depends on the dimension L_{M} of the multilayer ceramic capacitor 10 in the height direction x, it is preferable that the dimension T_{S} of the first spacer 52 and the second spacer 54 in the height direction x is, for example, about 50 μm or more and about 250 μm or less. For example, when the dimension L_{M} of the multilayer ceramic capacitor 10 in the length direction is about 1.6 mm, the dimension W_{M} of the multilayer ceramic capacitor 10 in the width direction is about 0.8 mm, and the dimension T_{M} of the multilayer ceramic capacitor 10 in the height direction x is about 0.8 mm, it is preferable that the dimension T_{S} of the first spacer 52 and the second spacer 54 in the height direction x is about 160 μm. A portion of the first spacer 52 and the second spacer 54 may include protrusions and recesses. When a portion of the first spacer 52 and the second spacer 54 includes protrusions and recesses, it is preferable that the dimension T_{S} of the first spacer 52 and the second spacer 54 in the height direction x is, for example, at least about 160 μm.

The first spacer 52 and the second spacer 54 include metal powder. The metal powder includes, for example, Cu, Ni, or an alloy of Cu and a metal component (such as Ni), and Sn. The metal powder may additionally include, for example, Ag or a resin component (such as rosin), and Cu or Ni may be coated with Ag. Thus, the spacers have a melting point such that the spacers do not melt even when soldering is performed to mount the multilayer ceramic electronic component 1 onto a substrate and are not deformed by heat, and therefore it is possible to mount the multilayer ceramic electronic component 1 while maintaining a preferable shape during soldering. This is not a limitation, and the metal powder may include another metal component. Because the first spacer 52 and the second spacer 54 include Cu, Ni, or an alloy of Cu and a metal component (for example, Ni), and Sn, it is easy to metal-join the first spacer 52 and the second spacer 54 and the outer electrodes 30a and 30b of the multilayer ceramic capacitor 10.

The first spacer 52 and the second spacer 54 may additionally include, for example, phenol resin as a resin component. In this case, phenol resin covers particles of the metal powder and is interspersed so that the gaps between the particles are filled with the phenol resin. Because phenol resin has high heat resistance, it is possible to reduce an evaporation amount in a heat treatment step when the spacers are formed. Therefore, it is possible to reduce air gaps in the spacer. This is not a limitation, and the spacers may include, for example, in addition to phenol resin, epoxy resin or rosin.

The first spacer 52 and the second spacer 54 may include, for example, metal powder in a resin. When the spacers include more resin component than metal powder, the spacers can absorb vibration of the multilayer ceramic capacitor 10 with the resin component and reduce vibration transmitted to the substrate. In this case, the surfaces of the first spacer 52 and the second spacer 54 may be plated.

It is possible to detect components of the first spacer 52 and the second spacer 54, for example, as follows.

The multilayer ceramic electronic component 1 is cross-section polished perpendicularly or substantially perpendicularly to the mounting surface S and up to about ⅙ W in the width direction y to expose a cross section in the height direction x and the length direction z (LT cross section). It is possible to detect components of the first spacer 52 and the second spacer 54 by qualitatively analyzing the polished cross section by performing, for example, EDX using FE-SEM (SU8230, made by Hitachi High-Tech Corporation).

It is possible to observe metal types in the first spacer 52 and the second spacer 54 and differences in metal types of plating, if the first spacer 52 and the second spacer 54 are plated, by magnifying an image of the polished cross section with a total magnification of about 50 times by using, for example, a microscope (BX-51, made by Olympus Corporation) and capturing the magnified image by using a microscope digital camera (DP22, made by Olympus Corporation).

This is not a limitation, and it is possible to observe metal types in the first spacer 52 and the second spacer 54 and differences in metal types of plating, if the first spacer 52 and the second spacer 54 are plated, by, for example, capturing an image with a total magnification of about 100 times or more and about 500 times or less by using a microscope (Axio (registered trademark)-Imager-MAT, made by ZEISS Corporation). In addition, for example, cross-section polishing may be performed up to about ½ W in the width direction y.

The third spacer 56 is connected to a portion of the multilayer body 12, a portion of the first spacer 52, and a portion of the second spacer 54. To be more specific, the third spacer 56 covers the fourth surface 52d of the first spacer 52 and covers the third surface 54c of the second spacer 54. It is preferable that the third spacer 56 covers, for example, about 50% or more the fourth surface 52d of the first spacer 52, and it is preferable that the third spacer 56 covers, for example, about 50% or more of the third surface 54c of the second spacer 54. In this case, it is preferable that the third spacer 56 continuously covers the gap between the first spacer 52 and the multilayer body 12 and the gap between the second spacer 54 and the multilayer body 12. It is preferable that the third spacer 56 continuously covers a surface of the multilayer body 12. However, this is not a limitation, and the third spacer 56 may be disposed discontinuously in the longitudinal direction (length direction z) of the multilayer ceramic capacitor 10. Thus, it is possible to increase the distance between a central portion in the length direction z, which vibrates the most, and the multilayer ceramic electronic component 1, and therefore it is possible to reduce the probability that a mounting substrate contacts the multilayer ceramic electronic component 1.

The third spacer 56 may cover the fifth surface 52e and the sixth surface 52f of the first spacer 52 and the fifth surface 54e and the sixth surface 54f of the second spacer 54. The third spacer 56 may continuously cover the fifth surface 52e and the sixth surface 52f of the first spacer 52, the fifth surface 54e and the sixth surface 54f of the second spacer 54, and the fifth surface 12e and the sixth surface 12f of the multilayer ceramic capacitor 10. With such a configuration, the third spacer 56 provides insulation, and therefore it is possible to position the multilayer ceramic electronic components 1 close to each other. Although portions of the multilayer ceramic capacitor 10 to be covered by the third spacer 56 is not particularly limited, it is preferable that the third spacer 56 does not cover a surface (the first surface 12a) of the multilayer ceramic electronic component 1 on the non-mounting surface side such that the mounting surface side (the second surface 12b) can be distinguished.

Here, a central region of the third spacer 56 is defined as a ½ L portion of the multilayer ceramic electronic component 1 in the length direction z. An end region of the third spacer 56 is defined as a portion of the third spacer 56 in contact with the first spacer 52 or a portion of the third spacer 56 in contact with the second spacer 54. In the longitudinal direction (length direction z) of the multilayer ceramic capacitor 10, it is preferable that the thickness t1 of the central region of the third spacer 56 is smaller than each of the thicknesses t2 and t3 of the end regions of the third spacer 56. That is, it is preferable that the third spacer 56 is curved toward the mounting surface side. In other words, it is preferable that the third spacer 56 has a shape such that the third spacer 56 curves up to the first spacer 52 and the second spacer 54. Thus, it is possible to reduce the possibility that the third spacer 56 contacts the mounting surface S when the multilayer ceramic capacitor 10 vibrates.

An example of a method of measuring the thickness t1 of the central region of the third spacer 56 and the thicknesses t2 and t3 of the end regions of the third spacer 56 will be described.

The multilayer ceramic electronic component 1 is polished up to about ½ W in the width direction y to expose a cross section (LT cross section). In the exposed cross section, by using, for example, a digital microscope (VHX-6000, made by KEYENCE Corporation), the distance from the second surface 12b of the multilayer body 12 to a surface of the third spacer 56 on the mounting surface side is measured.

Moreover, as illustrated in FIGS. 6 and 8, it is preferable that the length w1 of the central region of the third spacer 56 in the width direction y is smaller than each of the lengths w2 and w3 of the end regions of the third spacer 56 in the width direction y. With such a shape, it is possible to increase adhesion between the multilayer body 12 and the first and second spacers 52 and 54.

It is preferable that the third spacer 56 is disposed between the multilayer body 12 and the first spacer 52 and between the multilayer body 12 and the second spacer 54. Thus, the gap between the multilayer body 12 and the first spacer 52 and the gap between the multilayer body 12 and the second spacer 54 are filled with the third spacer 56, and therefore, when vibration occurs, it is possible to reduce the probability that an edge portion the first spacer 52 on the central side (an edge portion where the first surface 52a and the fourth surface 52d intersect) or an edge portion of the second spacer 54 on the central side (edge portion where the first surface 54a and the third surface 54c intersect) contacts and breaks the multilayer ceramic capacitor 10.

It is preferable that the color of the multilayer ceramic electronic component 1 when seen from the bottom surface (mounting surface side) and the color of the multilayer ceramic electronic component 1 when seen from the flat surface (non-mounting surface) side are different. When the colors are different, it is easy to select the direction in which the multilayer ceramic electronic component 1 is to be mounted on a substrate, and it is possible to reduce the probability that the multilayer ceramic electronic component 1 is mounted on the substrate with a surface different from a surface to be mounted.

The third spacer 56 includes, for example, carbon, Co, Al, or Cr. The third spacer 56 may additionally include, for example, epoxy resin, hardener, or another organic solvent.

For example, when the third spacer 56 includes a large amount of carbon, it is possible to make the color of the third spacer close to black. When the third spacer 56 includes a large amount of Co, Al, or Cr, it is possible to make the color of the third spacer 56 closer to blue. It is possible to change the color by using any appropriate material.

It is preferable that the content of the material for changing the color is, for example, about 0.1 wt % or more and about 5.0 wt % or less with respect to the solid component of the third spacer 56, that is, the amount of a solid component excluding a solvent (for example, epoxy resin, phenol resin), an additive (for example, coupling agent, catalyst), and an inorganic material (for example, silica, alumina). If the weight percentage is small, a change in color is insufficient, and the color might not be correctly recognized during image processing. If the weight percentage is too large, the third spacer 56 may short-circuit the first outer electrode 30a and the second outer electrode 30b or may short-circuit the first spacer 52 and the second spacer 54. Depending on the distribution of the materials, there may be a region in which the color is partially different. Even in such a case, it is possible to select the direction as long as the color is sufficiently different. On the mounting surface side, it is preferable that the color is different in, for example, about half or more of the area of the region between the first spacer 52 and the second spacer 54.

In order to distinguish between a portion where the third spacer 56 is present and the other portions, an example of a method of measuring the color of the mounting surface side of the multilayer ceramic electronic component 1 and the color of the non-mounting surface side of the multilayer ceramic electronic component 1 will be described.

The first surface 12a, which is on the non-mounting surface side of the multilayer ceramic electronic component 1, and the second surface 12b, which is on the mounting surface side of the multilayer ceramic electronic component 1, are measured by using a digital microscope (VHX-6000, made by KEYENCE Corporation) (RGB measurement). The measurement conditions are such that the brightness is auto “100”, the gain is auto “100”, and the reflection removal is ring removal “normal”. Regarding the mounting surface side, on about ½ W of the multilayer ceramic electronic component 1, about ½ L of the multilayer ceramic electronic component 1, a contact point between the first spacer 52 and the multilayer body 12, and a contact point between the second spacer 54 and the multilayer body 12 are measured. Regarding the non-mounting surface side, on about ½ W of the multilayer ceramic electronic component 1, about ½ L of the multilayer ceramic electronic component 1, the vicinity of a contact point between the first outer electrode 30a and the multilayer body 12, and the vicinity of a contact point between the second outer electrode 30b and the multilayer body 12 are measured. It is defined that the color is different if the value of any of R, G, and B is different by about 10 or more when the mounting surface and the non-mounting surface of the multilayer ceramic electronic component 1 are measured. At this time, it is determined that the color is different if the color of at least one of the measurement portions is different.

Next, an example of a method of manufacturing the multilayer ceramic electronic component 1 according to an example embodiment of the present invention will be described.

First, electroconductive pastes for a dielectric sheet and an inner electrode are prepared. The electroconductive pastes for a dielectric sheet and an inner electrode include a binder and a solvent. It is possible to use a known binder and a known solvent.

Next, on a dielectric sheet on which an inner electrode pattern is not printed and on a dielectric sheet, the electroconductive paste for an inner electrode is printed in a predetermined pattern by, for example, screen printing, gravure printing, or the like to prepare a dielectric sheet on which a first inner electrode pattern is printed and a dielectric sheet on which a second inner electrode pattern is printed.

Next, a predetermined number of dielectric sheets on which inner electrode patterns are not printed are stacked, and a portion to become the inner layer portion 18 is formed by sequentially stacking, on the dielectric sheets, the dielectric sheets on which the first inner electrode pattern and the second inner electrode pattern are printed. Moreover, a multilayer sheet is made by stacking, on the portion to become the inner layer portion 18, a predetermined number of dielectric sheets on which inner electrode patterns are not printed.

Next, a multilayer block is made by pressing the multilayer sheet in the stacking direction by using, for example, an isostatic press or the like.

Next, the multilayer block is cut into multilayer chips each having a predetermined size. At this time, vertices and edges of the multilayer chips may be rounded by performing, for example, barrel polishing or the like.

Next, the multilayer chip is fired to make the multilayer body 12. Although the firing temperature depends on the materials of the dielectric layer 14 and the inner electrode 16, it is preferable that the firing temperature is, for example, about 900° C. or higher and about 1400° C. or lower.

Next, the underlying electrode layer 32 is formed by applying an electroconductive paste to become the underlying electrode layer 32 to the third surface 12c and the fourth surface 12d of the multilayer body 12. In the present example embodiment, a baked layer is formed as the underlying electrode layer 32. When the baked layer is to be formed, the underlying electrode layer 32 is formed by applying an electroconductive paste including a glass component and a metal by, for example, using a method such as dipping and then performing a baking treatment. It is preferable that the temperature of the baking treatment is, for example, about 700° C. or higher and about 900° C. or lower.

When the underlying electrode layer 32 is to be formed as an electroconductive resin layer, the electroconductive resin layer can be formed by using the following method. The electroconductive resin layer may be formed on the surface of the baked layer, or, without forming the baked layer, only the electroconductive resin layer may be formed directly on the multilayer body.

As a method of forming the electroconductive resin layer, an electroconductive resin paste including a resin and a metal component is applied onto the baked layer or onto the multilayer body, heat treatment is performed at a temperature of, for example, about 250° C. or higher and about 550° C. or lower to thermoset the thermosetting resin, thus forming the electroconductive resin layer. It is preferable that the atmosphere of the heat treatment is, for example, an N₂ atmosphere. In order to reduce or prevent scattering of the thermosetting resin and to prevent oxidation of various metal components, it is preferable that oxygen concentration is, for example, about 100 ppm or lower.

When the underlying electrode layer 32 is to be formed as a thin film layer, it is possible to form the underlying electrode layer 32 by using a thin film forming method such as sputtering, vapor deposition, or the like, for example. The underlying electrode layer 32 formed as a thin film layer is a layer of deposited metal particles having a thickness of, for example, about 1 μm or less.

The underlying electrode layer 32 may be omitted, and the plating layer 34 may be provided on the exposed portion of the inner electrode 16 of the multilayer body 12. In this case, it is possible to form the plating layer 34 by using the following method, for example.

Plating is performed on the third surface 12c and the fourth surface 12d of the multilayer body 12 to form an underlying plating electrode on the exposed portion of the inner electrode 16. Although plating may be performed by, for example, either of electrolytic plating or electroless plating, electroless plating has a disadvantage that the process is complex because preprocessing using a catalyst or the like is necessary to increase deposition rate. Accordingly, normally, it is preferable that electrolytic plating is used. As the plating technique, it is preferable that barrel plating is used, for example. As necessary, an upper plating electrode may be formed on the surface of the lower plating electrode in the same manner.

Subsequently, the plating layer 34 is formed on the surface of the underlying electrode layer 32, the surface of the electroconductive resin layer, and the surface of the upper plating electrode. In the present example embodiment, for example, an Ni plating layer and an Sn plating layer are formed on the baked layer. The Ni plating layer and the Sn plating layer are sequentially formed, for example, by using barrel plating.

In this way, the multilayer ceramic capacitor 10 is manufactured.

Next, an example of a method of disposing the first spacer 52 and the second spacer 54 on the multilayer ceramic capacitor 10 will be described.

A first spacer forming paste for forming the first spacer 52 and a second spacer forming paste for forming the second spacer 54 are prepared. The first spacer forming paste and the second spacer forming paste include, for example, a metal including at least one of Cu, Ni, Sn, Ag, or the like and a resin component. However, this is not a limitation, and the first spacer forming paste and the second spacer forming paste may be an electroconductive paste.

Next, the first spacer forming paste and the second spacer forming paste are disposed on a holding substrate (for example, an alumina plate) by using a screen printing method, a dispensing method, or the like, for example. Next, the multilayer ceramic capacitor 10 is placed on the upper surface of the spacer forming paste in a position facing the holding substrate. At this time, the first outer electrode 30a and the first spacer forming paste are positioned relative to each other, the second outer electrode 30b and the second spacer forming paste are positioned relative to each other, and the first spacer forming paste and the second spacer forming paste are applied to the multilayer ceramic capacitor 10. Subsequently, the first spacer 52 and the second spacer 54 are formed by performing heat treatment.

It is also possible to dispose the first spacer 52 and the second spacer 54 on the multilayer ceramic capacitor 10 by using the following method, for example.

The multilayer ceramic capacitor 10 is disposed on a holding substrate (for example, an alumina plate) by using an adhesive. On the outer electrodes 30 of the multilayer ceramic capacitor 10 disposed on the holding substrate, the spacer forming pastes are disposed by using a screen printing method, a dispensing method, or the like. The first outer electrode 30a and the first spacer forming paste are positioned relative to each other, the second outer electrode 30b and the second spacer forming paste are positioned relative to each other, and the first spacer forming paste and the second spacer forming paste are applied to the multilayer ceramic capacitor 10.

In the spacer disposing step described above, it is possible to form the first spacer 52 and the second spacer 54 having preferable shapes in preferable location by changing the amounts of pastes and changing the design of a mask. Subsequently, the first spacer 52 and the second spacer 54 are formed by performing heat treatment.

Next, an example of a method of disposing the third spacer 56 on the multilayer ceramic capacitor 10 will be described.

The surface of the multilayer ceramic capacitor 10 on which the first spacer 52 and the second spacer 54 are disposed is washed by using a solvent. After washing has been finished, the multilayer ceramic capacitor 10 on which the first spacer 52 and the second spacer 54 are disposed is aligned so that the first spacer 52 and the second spacer 54 face upward.

Next, a third spacer forming paste for forming the third spacer 56 is prepared. The third spacer forming paste for forming the third spacer 56 is an insulating paste. It is possible to change the color of the third spacer 56 by adding any appropriate material as an additive.

Next, the third spacer 56 is formed between the first spacer 52 and the second spacer 54 by using, for example, a dispenser or screen printing on the multilayer ceramic capacitor 10 on which the first spacer 52 and the second spacer 54 are disposed. By adjusting the amount of the third spacer forming paste, it is possible to change the degree to which the third spacer 56 curves up to the first spacer 52 and the second spacer 54.

When the gap between the multilayer body 12 and the first spacer 52 and the gap between the multilayer body 12 and the second spacer 54 are to be filled with the third spacer 56, it is possible to do so by disposing the third spacer forming paste and then performing vacuuming. By changing the time and pressure of vacuuming, it is possible to change the degree to which the gaps are filled.

Subsequently, for example, heating is performed for about 20 minutes or longer and about 80 minutes or shorter at a temperature of about 100° C. or higher and about 200° C. or lower.

Through the process described above, the multilayer ceramic electronic component 1 according to the present example embodiment is manufactured.

The present invention is not limited to the example embodiments of the present invention described above.

That is, it is possible to make various modifications to the example embodiments described above in terms of mechanism, shape, material, number/amount, position, configuration, and the like without departing from the scope and spirit of the present invention, and such modifications are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer ceramic capacitor including a multilayer body and two outer electrodes;
a first spacer connected to one of the two outer electrodes;
a second spacer connected to another of the two outer electrodes; and
a third spacer between the first spacer and the second spacer; wherein the multilayer body includes a first surface on a non-mounting surface side; and
a color of the first surface is different from a color of the third spacer.

2. The multilayer ceramic electronic component according to claim 1, wherein, in a longitudinal direction of the multilayer ceramic capacitor, a thickness of a central region of the third spacer is smaller than a thickness of an end region of the third spacer.

3. The multilayer ceramic electronic component according to claim 1, wherein, in a longitudinal direction of the multilayer ceramic capacitor, the third spacer is discontinuously provided.

4. The multilayer ceramic electronic component according to claim 1, wherein the third spacer is located between the multilayer body and the first spacer or between the multilayer body and the second spacer.

5. The multilayer ceramic electronic component according to claim 1, wherein a stacking direction of the multilayer body is perpendicular or substantially perpendicular to a mounting surface.

6. The multilayer ceramic electronic component according to claim 1, wherein, in a longitudinal direction of the multilayer ceramic capacitor, a dimension of a central region of the third spacer in a width direction is smaller than a dimension of an end region of the third spacer in the width direction.

7. The multilayer ceramic electronic component according to claim 1, wherein the third spacer is located between the multilayer body and the first spacer and between the multilayer body and the second spacer.

8. The multilayer ceramic electronic component according to claim 1, wherein a content of a material to change the color of the third spacer is about 0.1 wt % or more and about 5.0 wt % or less with respect to an amount of a solid component of the third spacer excluding a solvent, an additive, and an inorganic material.

9. The multilayer ceramic electronic component according to claim 1, wherein the third spacer includes carbon, Co, Al, or Cr.

10. The multilayer ceramic electronic component according to claim 1, wherein the third spacer covers a portion of the multilayer body, a portion of the first spacer, and a portion of the second spacer.

11. The multilayer ceramic electronic component according to claim 10, wherein the third spacer covers about 50% or more of a surface of the first spacer and about 50% or more of a surface of the second spacer.

12. The multilayer ceramic electronic component according to claim 1, wherein, in a longitudinal direction of the multilayer ceramic capacitor component, the third spacer continuously covers a gap between the first spacer and the multilayer body and a gap between the second spacer and the multilayer body.

13. The multilayer ceramic electronic component according to claim 1, wherein each of the first and second spacers has a hexahedral or substantially hexahedral shape.

14. The multilayer ceramic electronic component according to claim 1, wherein a dimension of each of the first and second spacers in a height direction of the multilayer ceramic capacitor is about 50 μm or more and about 250 μm or less.

15. The multilayer ceramic electronic component according to claim 1, wherein each of the first and second spacers includes Cu, Ni, or an alloy of Cu and a metal component, and Sn.

16. The multilayer ceramic electronic component according to claim 15, wherein each of the first and second spacers further includes phenol.

17. A multilayer ceramic electronic component comprising:
a multilayer ceramic capacitor including a multilayer body and two outer electrodes;
a first spacer connected to one of the two outer electrodes; and
a second spacer connected to another of the two outer electrodes; wherein
the multilayer body includes:
a second surface on a mounting surface side; and
a first surface on a non-mounting surface side and facing the second surface; and
in a direction connecting the first surface and the second surface, a color of a mounting surface of the multilayer body is different from a color of a non-mounting surface of the multilayer body.

18. The multilayer ceramic electronic component according to claim 17, further comprising, a third spacer between the first spacer and the second spacer.
